(19) United States
(12) Patent Application Publication
(10) Pub. No.: US 2009/0067626 A1
(43) Pub. Date: Mar. 12, 2009

(54) REGION-BASED TRANSFORM DOMAIN VIDEO SCRAMBLING

(75) Inventors: Frederic A. Dufaux, Bois D'Amont (FR); Ebrahimi Touradj, Pully (CH)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: Emittall Surveillance S.A.

(21) Appl. No.: 12/066,165

(22) PCT Filed: Nov. 2, 2006
(86) PCT No.: PCT/IB06/03100

§ 371 Date: Jul. 10, 2008

Related U.S. Application Data
(60) Provisional application No. 60/597,028, filed on Nov. 4, 2005.

(51) Int. Cl. H04N 7/167

(52) U.S. Cl. 380/217

(57) ABSTRACT

A video communication system, for example, video surveillance and video conferencing, is disclosed in which regions of interest of video scenes are scrambled to protect privacy and/or allow anonymous participation. The regions of interest may be arbitrary and selectable by the participant or user, such as the face of the participant. Initially, the video content is analyzed to locate an arbitrary shape of interest, such as a human face or part of a human body. Once the region of interest is located, it is scrambled, for example, in conjunction with two well known video coding schemes; MPEG-4 and Motion JPEG-2000. The arbitrary regions can be scrambled in the transform-domain during coding and reversibly encrypted to allow authorized users to decrypt and decode the regions of interest.

### CROSS REFERENCE TO RELATED APPLICATIONS

The present application is a continuation-in-part of International Patent Application No. PCT/IB2006/002083, filed on Jul. 31, 2006, which claims priority to and the benefit of U.S. Provisional Patent Application No. 60/595,734, filed on Aug. 5, 2005. The present application also claims priority to and the benefit of U.S. Provisional Patent Application No. 60/597,028, filed on Nov. 4, 2005, all hereby incorporated by reference.

### BACKGROUND OF THE INVENTION

1. Field of the Invention

The present invention relates to a method for se with visual communication systems, such as video surveillance, video conferencing, video telephony and Internet video chat, video communication systems, that selectively scrambles regions of interest in a video scene in the transform domain using various known video encoding techniques, such as MPEG-4, Motion JPEG 2000 and others, in order to protect privacy and/or enable anonymous participation in a video communication. The regions of interest can also be reversibly encrypted so that authorized users can decode and decrypt the regions of interest.

2. Description of the Prior Art

Various video communication systems are known in the art. As used herein, such video communication systems are defined to include video conferencing, video telephony and Internet video chat systems which are capable of one and two way communication of live video content between two or more participants. Such video communication systems are also defined video surveillance systems in which regions of interest of a scene may be scrambled for privacy protection to prevent, for example, the identity of individuals, objects and/or places from being revealed. Examples of such video communication systems in U.S. Pat. Nos. 5,550,754; 5,867,494; 6,205,177; 6,249,318; 6,560,284; 6,608,636; 6,665,389; and 6,909,708 as well as US Patent Application Publication Nos. US 2002/0049616 A1; US 2004/0008249 A1; and US 2004/0008635 A1, all hereby incorporated by reference.

Such video communication systems are known to be used in a myriad of applications. For example, chat rooms are very popular on the Internet. Besides its ease and convenience to communicate, part of its appeal resides in the anonymity it provides. Thanks to technological advances, many chat room applications, such as Yahoo Messenger and MSN Messenger, now offer the possibility of a video link in order to enhance the communication. The video provides a desirable sense of human contact. Other applications include video conferencing as described in detail in U.S. Pat. No. 5,867,494 and US Patent Application Publication No. US 2004/0008635 A1, hereby incorporated by reference. U.S. Pat. No. 6,665,389 B1 discloses the use of video conferencing for an interactive dating service.

In some applications, it may be necessary for one of the participants to the video communication to be anonymous. For example, participants in an interactive dating service may choose to initially be anonymous. In addition, certain news sources may wish to remain anonymous. U.S. Pat. No. 6,665,389 and US Patent Application Publication No. US 2004/0008635 A1 have attempted to resolve this problem. Unfortunately, the solution is to totally block the video portion of the communication, which defeats the purpose of the video communication. Thus, there is a need for a video communication system which allows one or more of the participants to selectively participate in a video communication without defeating the purpose of the video communication system.

### SUMMARY OF THE INVENTION

The present invention relates to a method for use with video communication systems, such as video surveillance and video conferencing systems, in which regions of interest in a video scene are selectively scrambled to protect privacy and/or enable anonymous participation in a video communication. The regions of interest can be of any arbitrary shape, such as the face of the participant. Initially, the video content is analyzed to locate an arbitrary shape of interest, such as a human face or part of a human body. Once the region of interest is located, it is scrambled, for example, in conjunction with two well known video encoding schemes, such as MPEG-4 and Motion JPEG-2000. In accordance with an important aspect of the invention, the regions of interest are scrambled in the transform-domain during video encoding. The regions of interest can also be reversibly encrypted so that authorized users can decode and decrypt the regions of interest.

### DESCRIPTION OF THE DRAWING

These and other advantages of the present invention will be readily understood with reference to the following specification and attached drawing wherein:

FIG. 1 is a generalized block diagram of the processing steps utilized in the present invention.

FIG. 2 is a block diagram of transform domain scrambling in accordance with an alternate embodiment of the invention.

FIG. 3 is a block diagram of a Motion JPEG 2000 encoder illustrating transform domain scrambling.

FIG. 4 is a block diagram of a Motion JPEG 2000 decoder illustrating transform domain scrambling.

FIG. 5 illustrates an example wavelet scrambling in which co-efficient in sub-bands 1, 2 and 3 are scrambled for an image decomposed with 3 resolution levels.

FIG. 6 is a block diagram of an MPEG-4 encoder illustrating transform domain scrambling.

FIG. 7 is a block diagram of an MPEG-4 decoder illustrating transform domain scrambling.

FIG. 8 illustrates 8×8 DCT block scrambling in which all 63 co-efficients have been scrambled.

### DETAILED DESCRIPTION

The present invention relates to a method for video communication systems including video surveillance and video conferencing systems in which regions of interest in a video scene are selectively scrambled to protect privacy and/or enable anonymous participation in a video communication. The regions of interest can be of any arbitrary shape, such as the face of the participant. Initially, the video content is analyzed to locate an arbitrary shape of interest, such as a human face or part of a human body. Once the region of interest is located, it is scrambled, for example, by way of a known video encoding scheme; such as MPEG-4 and Motion JPEG-2000. In accordance with an important aspect of the invention, the regions of interest are scrambled in the transform-domain during coding. The regions of interest can also be reversibly encrypted, as discussed in detail below so that authorized users can decode and decrypt the regions of interest.

The MPEG-4 video encoding scheme is described in detail in “The MPEG-4 Book”, Prentice Hall, by Ebrahimi and Pereira, 2002, hereby incorporated by reference. The Motion JPEG 2000 video encoding scheme is described in detail in “The JPEG 2000 Still Image Compression Standard” by Skodras et al, IEEE Signal Processing Magazine, vol. 18, no. 5, pp. 36-58, September 2001 and “JPEG 2000: Image Compression Fundamentals, Standards and Practice” Kluwer Academic Publishers 2002, both hereby incorporated by reference.

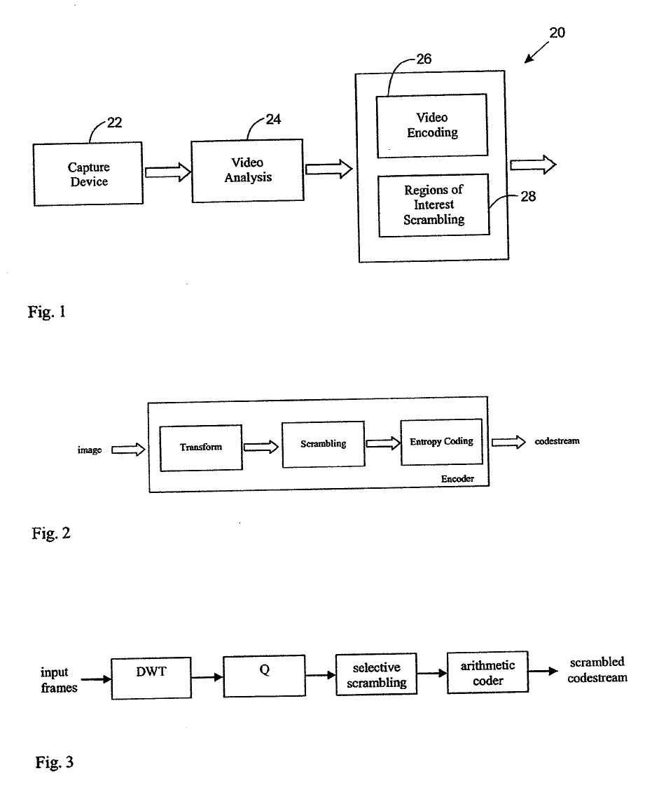

Referring first to FIG. 1, a video communication system for use with the method in accordance with the present invention, is generally identified with the reference numeral 20. The video communication system 20 includes a video capture device 22, a video analysis application 24 and a video encoding application 26.

The video content for each participant in the video communication system 20 is first acquired by the video capture device 22, for example, a visible spectrum, near-infrared or infrared camera. The near infrared and infrared cameras allow for low light applications without additional lighting. The video capture device 22 may also be a relatively low cost conventional web cam, for example, a Quick Cam Pro 4000, as manufactured by Logitech. Such conventional web cams come with standard software for capturing and storing video content on a frame by frame basis. Virtually any video capture device 22 is suitable for this purpose.

In accordance with one aspect of the invention, only portions, i.e. regions of interest 28, of the video content are scrambled by a video analysis application 24 running on a PC (not shown), such as a standard laptop PC with a 2.4 GHz Pentium processor. In accordance with an important aspect of the invention, the system analyzes the video content to identify arbitrary shapes in a video frame, such as a human face or human skin and only scrambles the arbitrary shapes. Various video analysis applications 24 are suitable for identifying objects in a video scene, such as, human faces in a video frame, as disclosed in International Publication No. WO 2006/070249 A1, published on Jul. 6, 2006 and WO 2006/006081 A2, published on Jan. 19, 2006; “Neural Network Based Face Detection” by Rowley et al, IEEE Transactions On PAMI, vol. 20, no. 1, pp. 23-38, 1998; and “Rapid Object Detection Using a Boosted Cascade of Simple Features” by Viola et al, IEEE Proceedings CVPR, Hawaii, December 2001, all hereby incorporated by reference. Other conventional video analysis applications 24 may also be suitable. Detection of human skin is also known in the art. for example, as disclosed in “Statistical Color Models With Applications to Skin Detection” by Jones et al, TR 98-11, CRL, Compaq Computer Corp. December 1998 and “Optimum Color Spaces for Skin Detection” by Albiol et al, IEEE Proc. Inter. Conf. on Image Proc., Thessaloniki, Greece, October 2001, hereby incorporated by reference.

Once the regions of interest of a video scene are identified, the video content is encoded by conventional video encoding techniques, such as MPEG-4 and Motion JPEG 2000 or other video encoding techniques. In accordance with one aspect of the invention, the regions of interest are scrambled by the video encoding application 26. In particular, the scrambling technique is closely linked to the scheme used to encode the video. Many known video coding schemes are based on transform-coding. Namely, frames are transformed using an energy compaction transform, such as the Discrete Cosine Transform (DCT) or wavelet transform, which are known in the art. The resulting coefficients are then entropy coded using known techniques, such as Huffman or arithmetic coding.

Each region of interest is defined by a segmentation mask. In order to smooth and clean up the segmentation mask, a morphological filter may be applied. More specifically, small regions and holes are removed in the segmentation mask by opening (i.e. erosion followed by dilation) then a closing (i.e. dilation followed by erosion). A suitable morphological filter is disclosed in “Flat Zones Filtering, Connected Operators and Filters by Reconstruction” by Salembier et al, IEEE Transactions on Image Processing, vol. 3, no. 8, pp. 1153-1160, August 1995, hereby incorporated by reference.

In accordance with the present invention, various well-known video coding schemes are contemplated, such as MPEG-4 and Motion JPEG 2000. MPEG-4 is based on a motion compensated block-based DCT. Motion JPEG 2000 is an extension of JPEG 2000 for the coding of video sequences. It consists of the intra-frame coding of each frame using wavelet-based JPEG 2000.

Scrambling is closely linked to the scheme used to encode the video. Most video coding schemes are based on transform-coding. Namely, video frames are transformed using an energy compaction transform, such as the Discrete Cosine Transform (DCT) or wavelet transform. The resulting coefficients are then entropy coded using techniques such as Huffman or arithmetic coding. Basically, scrambling can be applied at three different stages: in the image-domain prior to coding, in the transform-domain during coding, or in the codestream-domain after coding. Image domain and bit stream domain processing are discussed in detail in International Patent Application No. PCT/IB2006/002083, filed on Aug. 1, 2005, hereby incorporated by reference.

The present invention relates to video scrambling of arbitrary regions in the transform domain as illustrated in FIGS. 2-8 and described below. More particularly, in transform domain scrambling, the region of interest is scrambled during encoding, as shown in FIG. 2. More specifically, scrambling takes place after the DCT or wavelet transform and before entropy coding 32. The sign of transform coefficients are randomly flipped corresponding to the region to be scrambled. Besides its simplicity, this approach does not adversely affect the subsequent entropy coding. Furthermore, thanks to the frequency analysis property of the transform, the strength of the scrambling can be controlled by restricting the scrambling to some frequencies. Besides its simplicity, this approach does not adversely affect the subsequent entropy coding. Furthermore, thanks to the frequency analysis property of the transform, the strength of the scrambling can be controlled by restricting the scrambling to some frequencies. Another benefit of this approach is that it preserves the syntax of the codestream, e.g. maintaining standard compliance. This enables content adaptation or transcoding at mid-network nodes or proxies, as is often required in a video delivery system. Moreover, in accordance with an important aspect of the invention, the scrambling is reversible. As such, authorized users can recover the video data without the loss of any data.

### Motion JPEG 2000

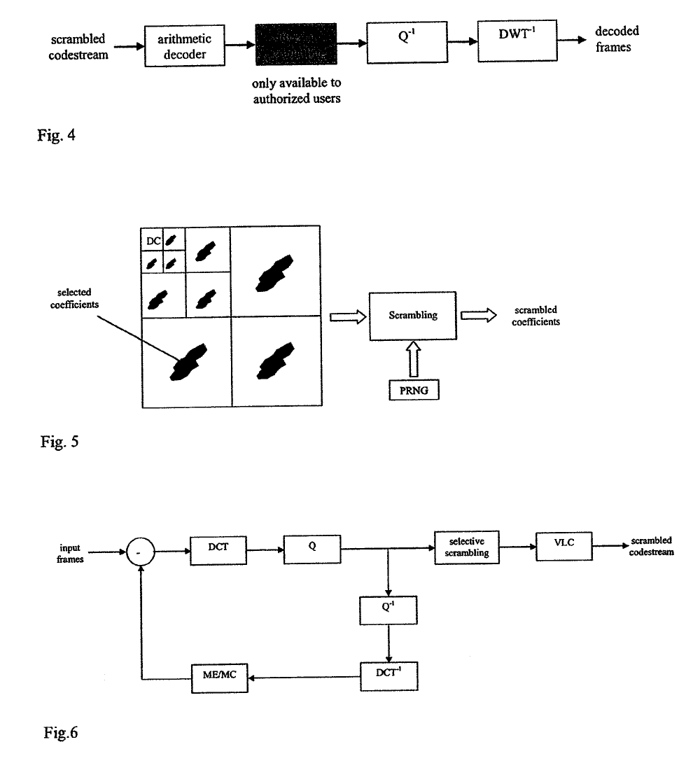

FIGS. 3-5 illustrate one embodiment of the invention in which scrambling of an arbitrary region of interest is done in the transform domain using Motion JPEG 2000 video encoding. FIG. 3 illustrates the principles of the present invention using a Motion JPEG 2000 video encoder while FIG. 4 illustrates a Motion JPEG 2000 decoder. As set forth in Ebrahimi et al, “The JPEG 2000 Still Image Compression Standard”, IEEE Signal Processing, vol. 18, no. 5, pp 36-58, September 2001 and Taubman et al, “JPEG 2000: Image Compression Fundamentals, Standards and Practice” Kluwer Academic Publishers, 2002, both hereby incorporated by reference, Motion JPEG 2000 coding is an extension of JPEG 2000 and consists of intra-frame coding of each frame using wavelet-based JPEG 2000.

As shown in FIG. 3, scrambling can be effectively applied after the Discrete Wavelet Transform (DWT) and quantization, and before the arithmetic coder. The process is fully reversible. At the decoder side, authorized users have merely to perform the exact inverse operation, as shown in FIG. 4.

The scrambling should have a minimal impact on coding efficiency. As the wavelet coefficients are strongly correlated, scrambling them would reduce coding performance; they are therefore unsuitable for scrambling. However, the signs of wavelet coefficients are typically weakly correlated, and are thus appropriate for scrambling. Furthermore, in general AC coefficients are weakly correlated whereas DC coefficients are strongly correlated. Therefore, AC coefficients are more suitable for scrambling.

In accordance with the present invention, quantized wavelet coefficients belonging to the AC sub-bands and corresponding to the regions of interest are scrambled by randomly flipping their sign, as shown in FIG. 5 Error! Reference source not found. A Pseudo Random Number Generator (PRNG) is used to drive the scrambling process. The amount of scrambling can be adjusted by restricting the scrambling to fewer resolution levels.

The proposed scrambling technique relies on a PRNG driven by a seed value. In accordance with the present invention, a SHA1PRNG algorithm, for example, as disclosed in Java Cryptography Architecture API Specification and reference, http://java.sun.com/j2se/1.4.2/docs/guide/security/CryptoSpec.html, hereby incorporated by reference, with a 64-bit seed may be used. Note that other PRNG could be used as well. In order to improve the security of the system, the seed can be frequently changed. The seed(s) of the PRNG may then be encrypted, for example by way of RSA, and inserted into the video stream. The scrambling process is reversible for authorized users which are in possession of the encryption key.

With this method, scrambled regions can have arbitrary shapes. The shape of the regions of interest has to be available at both the encoder for scrambling and decoder for unscrambling. This is done by transmitting the shape information as metadata either as part of the Motion JPEG 2000 codestream, or on a separate channel. More efficiently, asset forth in F. Dufaux and T. Ebrahimi, “Smart Video Surveillance System Preserving Privacy”, in SPIE Proc. Image and Video Communications and Processing 2005, San Jose, Calif., January 2005, hereby incorporated by reference, the shape can be implicitly embedded using the Region of Interest (ROI) mechanism of JPEG 2000.

Furthermore, an extension of the baseline JPEG 2000, Secured JPEG 2000 (JPSEC), for example, as disclosed in detail in JPEG 2000 Part 8 (JSPEC) FCD ISO/IEC JTC1/SC29 WG1 N3480, November 2004, hereby incorporated by reference, is of special interest. JPSEC defines an open framework for secure imaging, defining a powerful and flexible syntax. Using this JPSEC syntax, the seeds driving the PRNG and the scrambling process can be encrypted and embedded in the codestream. In this case, the resulting codestream is fully JPSEC compliant.

Straightforwardly, as the scrambling is merely flipping signs of selected wavelet coefficients, the technique requires negligible computational complexity. Moreover, unlike the MPEG-4 case, with Motion JPEG 2000, the scrambled regions can have an arbitrary shape.

### MPEG-4

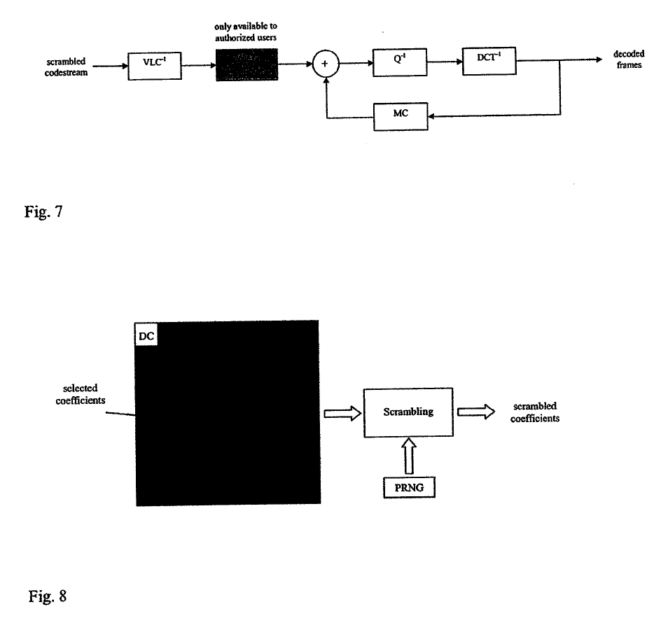

MPEG-4 is based on a motion compensated block-based Discrete Cosine Transform (DCT), as described in detail in T. Ebrahimi and F. Pereira, “The MPEG-4 Book”, Prentice Hall, 2002, hereby incorporated by reference. As both DCT and DWT are special cases of sub-band decompositions, the same scrambling approach for Motion JPEG 2000 can be used. However, in contrast with the Motion JPEG 2000 video encoding scheme, based on intra-frame coding, the MPEG-4 video encoding scheme uses inter-frame coding. As both the encoder and decoder contain the motion compensation loop, attention has to be paid for the scrambling process not to introduce a drift between these two loops. As such, scrambling can be effectively applied on the quantized DCT coefficients, and outside of the motion compensation loop, as illustrated in FIG. 6. At the decoder side, authorized users perform unscrambling of the coefficients resulting from entropy decoding, prior to the motion compensation loop, as depicted in FIG. 7. Straightforwardly, as the scrambling is kept out of the motion compensation loop, this allows for a fully reversible process for authorized users.

From FIG. 7, it should be clear that an unauthorized decoder, i.e. which is not capable of unscrambling, will use a different motion compensation loop than an authorized decoder. As a result, an unauthorized decoder will experience a drift, resulting in artifacts in the scrambled sequence. This undesirable effect can be removed by modifying the MacroBlock (MB) type decision during encoding. More precisely, unscrambled MBs in the current frame, co-located with a scrambled MB in the reference frame, are always INTRA coded. This modification of the MB type decision prevents the drift in motion compensation loop and consequently removes the artifacts in the scrambled sequence.

Straightforwardly, the shape of the scrambled region is restricted to match the 8×8 DCT blocks boundaries. In order to unscramble the codestream, authorized decoders need to know the shape of the regions of interest. The latter has therefore to be transmitted as metadata either in private data in the MPEG-4 codestream, or on a separate channel. In parallel, the encryption keys can be transmitted in a similar way.

In the case of MPEG-4, scrambling is performed by first identifying all of the blocks corresponding to the regions to be scrambled. For these blocks, all 63 AC coefficients are scrambled by randomly reversing their sign, as illustrated in FIG. 8. A Pseudo Random Number Generator (PRNG) is used to drive the scrambling process. Note that it is possible to scramble fewer AC coefficients in order to obtain a lighter scrambling, or reverse other bits in the binary representation of coefficients. However it may no longer be sufficient to effectively hide the content of the regions of interest.

Each frame is subdivided in 16×16 MacroBlocks (MB). Each MB is composed of four 8×8 luminance blocks and two 8×8 chrominance blocks. The DCT is performed on these 8×8 blocks, resulting in 64 DCT coefficients: one DC and 63 AC coefficients. In this application, all the blocks corresponding to the regions to be scrambled are identified. For these blocks, all 63 AC coefficients are scrambled as illustrated in FIG. 8. A pseudo random noise generator (PRNG) is then used to randomly inverse their sign.

The seed(s) of the PRNG may then be encrypted by way of an encryption key, for example RSA, and inserted into the video stream. The scrambling process is reversible for authorized users which are in possession of the encryption key.

Note that for the MPEG-4 case, the shape of the scrambled regions is restricted to match the 8×8 DCT blocks boundaries. The same technique could be used for the DCT-based JPEG and other DCT-based schemes, such as Advanced Video Coding (AVC)/H.264 or Motion JPEG.

The MPEG-4 technique is similar to the technique used in the Motion JPEG 2000 video encoding scheme. More particularly, wavelet coefficients belonging to the AC sub-bands and corresponding to the region to be scrambled have their sign randomly flipped, as shown in FIG. 8. For example, assume an image decomposed with 3 resolution levels. Scrambling coefficients in all AC sub-bands, i.e. levels 1, 2 and 3, results in a strong scrambling. Subsequently, as previously a PRNG is used to randomly inverse the sign of the corresponding coefficients. The amount of scrambling could be decreased by restricting the scrambling to fewer resolution levels; however it may no longer effectively hide the regions of interest.

As mentioned above, the shape of the scrambled region is restricted to match the 8×8 DCT blocks boundaries. In order to unscramble the codestream, authorized decoders need to know the shape of the regions of interest. The latter is transmitted as metadata either in private data in the MPEG-4 codestream, or on a separate channel. In parallel, the encrypted seeds can be transmitted in a similar way.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

1. A method for selectively scrambling regions of interest during video communication, the system comprising:
(a) capturing video content;
(b) analyzing said captured video content to determine a region of interest;
(c) scrambling said regions of interest in a transform domain defining encoded data; and
(d) encoding said video content for transport over a network.

2. The method as recited in claim 1, further including a step (e) encrypting said encoded data.

3. The method as recited in claim 2, wherein said step (e) comprises: reversibly encrypting said encoded data.

4. The method as recited in claim 1, wherein step (c) includes selecting a region of interest.

5. The method as recited in claim 4, wherein step (c) includes selecting an arbitrary shape for said region of interest.

6. The method as recited in claim 4, wherein step (c) includes selecting a pre-determined shape for said region of interest.

7. The method as recited in claim 1, wherein step (d) includes encoding said video content by way of a known video encoding scheme.

8. The method as recited in claim 7, wherein step (d) includes encoding said video content by way of Motion JPEG 2000.

9. The method as recited in claim 7, wherein step (d) includes encoding said video content by way of MPEG-4.

10. The method as recited in claim 2, wherein said step (e) comprises: reversibly encrypting said encoded data as a function of an encryption key.

11. The method as recited in claim 10, further including the step of transmitting said encryption key as private data in the video code stream or a separate channel.

12. The method as recited in claim 11, further including the step of transmitting the shape of said region of interest as private data in the video code stream or a separate channel
